(19) United States
(12) Patent Application Publication
(10) Pub. No.: US 2016/0014377 A1
(43) Pub. Date: Jan. 14, 2016

(54) BICYCLE CAMERA

(71) Applicant: FEDERATION ENTERPRISES (WA) PTY LTD, Subiaco, Western Australia (AU)

(72) Inventors: Kingsley FIEGERT, Subiaco (AU); Edward Joseph KHOURY, Bateman (AU); Andrew HAAGEN, Subiaco (AU)

(21) Appl. No.: 14/770,372

(22) PCT Filed: Feb. 27, 2014
(86) PCT No.: PCT/AU2014/000185

§ 371 Date: Aug. 25, 2015

(30) Foreign Application Priority Data
Mar. 1, 2013 (AU) 2013900688

(51) Int. Cl. H04N 7/18; B62J 6/04; B62J 99/00

(52) U.S. Cl. CPC H04N 7/18; B62J 99/00; B62J 6/04; B62J 2099/004

(57) ABSTRACT

A bicycle camera (10) comprising a housing (12) mountable to a seat post (14) of a bicycle (15). A camera (24) is provided within the housing (12) and a tail light (26) is provided within the housing (12) such that when the housing (12) is secured to the seat post (14), the tail light (26) provides illumination directed rearwardly of the bicycle (15) and the camera (24) is directed rearwardly of the bicycle (15) to capture images.

### FIELD OF THE INVENTION

The present invention relates to camera for mounting to a bicycle.

### BACKGROUND TO THE INVENTION

Many cyclists using the roads experience incidents with vehicles that create a dangerous situation for the cyclist. Such incidents may involve vehicles driving too close to the cyclist, cutting them off or simply abusing the rider. Unless an accident actually occurs, many of these instances involve the vehicle simply driving away, with the driver of the vehicle escaping any repercussions for their action.

The present invention relates to a camera device for mounting on a bicycle to capture images of such events. The camera comprises a mounting arrangement provided to allow easy attachment to the bicycle and secure mounting of the camera, along with features provided to give a visual indication of the presence and operation of the camera to drivers.

### SUMMARY OF THE INVENTION

According to one aspect of the present invention there is provided a bicycle camera comprising:

a housing mountable to a seat post of a bicycle;
a camera provided within the housing; and
a tail light provided within the housing;
wherein when the housing is secured to the seat post, the tail light provides illumination directed rearwardly of the bicycle and the camera is also directed rearwardly of the bicycle to capture images.

Preferably one or more indicator lights are provided in the housing such that the indicator lights illuminate when the camera is recording.

In a preferred embodiment, the indicator lights are provided in a ring around the camera and flash sequentially in a circular pattern.

Preferably the housing includes a first side surface to be located remote from the seat post in use and a second side surface to be located adjacent the seat post, wherein the second side surface includes a portion oriented at an angle to the first side surface such that when the housing is secured to the seat post, the first side surface is generally vertical.

Preferably the second side surface includes a projection defining a first surface portion and a second surface portion, the first surface portion comprising a planar surface extending from adjacent the first end wall of the housing to a location between the first end wall and a second end wall of the housing and the second surface portion comprising a planar surface extending from the first surface portion to adjacent the second end wall.

In a preferred embodiment, the first and second surface portions are angled relative to the first side surface such that the projection is generally a triangular prism in shape.

Preferably the first surface portion is longer than the second surface portion such that the intersection of the first and second surface portions is closer to the second end wall than the first end wall.

In a preferred embodiment, the housing is provided with a mounting bracket to secure the housing to the seat post, the mounting bracket comprising a member having convex first side surface for engaging the circular surface of the seat post and an opposed second side surface having a first connector thereon to engage with a second connector provided on the first surface portion of the housing.

Preferably the first connector comprises a slot extending longitudinally on the second side surface of the mounting bracket and the second connector comprises a rail which is mounted to the first surface portion of the housing, and wherein the rail includes grooves along opposed longitudinal sides thereof to receive inwardly facing flanges provided along opposed longitudinal sides of the slot.

In a preferred embodiment, the mounting bracket is provided with tabs extending outwardly from the second side surface thereof and a plurality of straps are provided, each including openings along the length thereof, such that an endmost opening in each strap may be engaged over one of the tabs and the strap then pulled around the seat post to engage over one of the tabs on the opposite side of the mounting bracket.

The straps are preferably formed of an elastic material such that the straps can be stretched around the seat post to engage the mounting bracket firmly.

A resilient arcuate pad is preferably provided to be placed on the first side surface of the mounting bracket.

Preferably the pad is tapered outwardly from an upper end to a lower end, wherein the taper is selected for the angle of the seat post in order to align the housing vertically.

Preferably a storage medium is provided within the housing to store images captured by the camera.

Preferably a connector is provided on the housing for retrieval of data from the storage medium via a cable.

In one embodiment, the housing comprises a first casing half and a second casing half, the first casing half being constructed of a transparent material and the tail lights and indicator lights being located to illuminate rearwardly through the first casing half.

Preferably an angle sensor is provided to detect if the angle of the bicycle exceeds a predetermined angle and to stop the camera recording after a predetermined time period.

### BRIEF DESCRIPTION OF THE DRAWINGS

The invention will now be described, by way of example, with reference to the following drawings, in which:

FIG. 1a is an upper rear perspective view of a bicycle camera in accordance with the present invention;

FIG. 1b is an upper front perspective view of the bicycle camera of FIG. 1a;

FIG. 1c is a lower rear perspective view of the bicycle camera of FIG. 1a;

FIG. 2a is a top view of the bicycle camera of FIG. 1:

FIG. 2b is a first side view of the bicycle camera of FIG. 1;

FIG. 2c is a front view of the bicycle camera of FIG. 1;

FIG. 2d is a second side view of the bicycle camera of FIG. 1;

FIG. 2e is a bottom view of the bicycle camera of FIG. 1;

FIG. 3 is an exploded view of the bicycle camera of FIG. 1:

FIG. 4a is a side view of the bicycle camera of FIG. 1 showing attachment of a mounting bracket to the housing;

FIG. 4b is a side view of the bicycle camera of FIG. 1 with the mounting bracket attached;

FIG. 5a is a front view of the bicycle camera of FIG. 1 attached to the seat post of a bicycle;

FIG. 5b is a side view of the bicycle camera of FIG. 1 attached to the seat post of a bicycle;

FIG. 5c is a rear view of the bicycle camera of FIG. 1 attached to the seat post of a bicycle;

FIG. 6a is an upper perspective view of a first step attaching the bicycle camera to the seat post;

FIG. 6b is an upper perspective view of a second step in attaching the bicycle camera to the seat post;

FIG. 6c is an upper perspective view of a third step in attaching the bicycle camera to the seat post;

FIG. 6d is an upper perspective view of the bicycle camera attached to the seat post;

FIG. 7a is a rear view of a bicycle with the bicycle camera attached;

FIG. 7b is a close up view of Detail a of FIG. 7a;

FIG. 7c is a side view of a bicycle with the bicycle camera attached;

FIG. 7d is a close up view of Detail B of FIG. 7c;

FIG. 8a is an upper perspective view of the bicycle camera with a first pad secured to the mounting bracket;

FIG. 8b is a side view of the bicycle camera of FIG. 8a secured to the seat post;

FIG. 8c is an upper perspective view of the bicycle camera with a second pad secured to the mounting bracket;

FIG. 8d is a side view of the bicycle camera of FIG. 8c secured to the seat post;

FIG. 8e is an upper perspective view of the bicycle camera with a third pad secured to the mounting bracket;

FIG. 8f is a side view of the bicycle camera of FIG. 8e secured to the seat post;

FIG. 8g is an upper perspective view of the bicycle camera with a fourth pad secured to the mounting bracket;

FIG. 8h is a side view of the bicycle camera of FIG. 8g secured to the seat post; and

FIG. 9 is a lower perspective view of the bicycle camera showing a cable attached to the housing for retrieving images from the storage medium and for recharging;

FIG. 10a is a top view of the bicycle era prior to engagement with a seat post using an adaptor;

FIG. 10b is a top view of the bicycle camera connected to the seat post with the adaptor; and

FIG. 10c is an upper perspective view of the bicycle camera connected to the seat post with the adaptor.

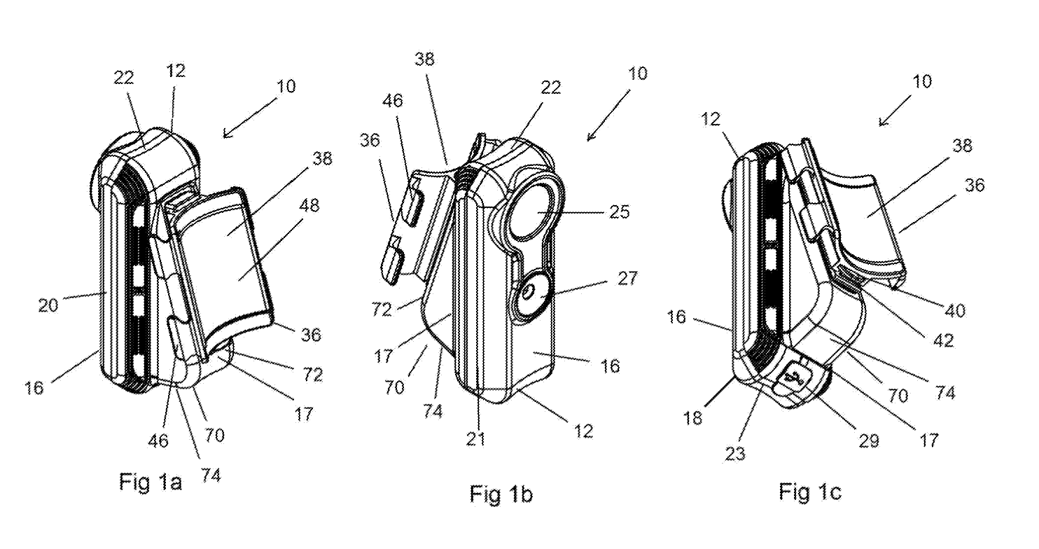

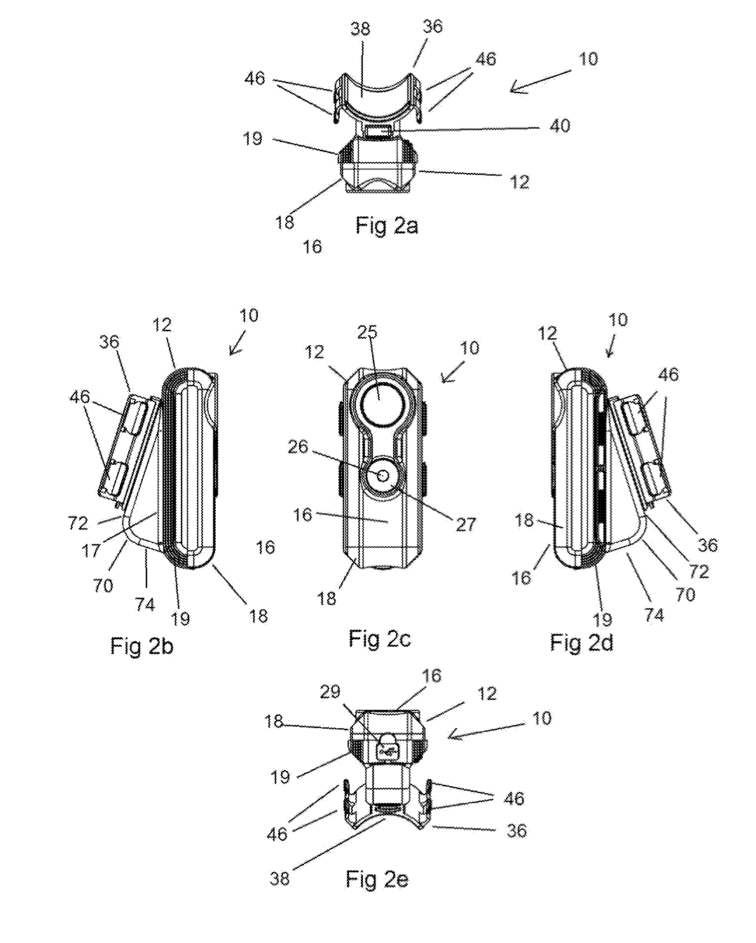

### DETAILED DESCRIPTION OF PREFERRED EMBODIMENTS

Referring to the Figures, there is shown a bicycle camera 10 comprising a housing 12 to be secured to a seat post 14 of a bicycle 15. The housing 12 includes generally a first side surface 16 which is to be located remote from the seat post 14 in use and a second side surface 17 which is to be located adjacent the seat post 14 in use.

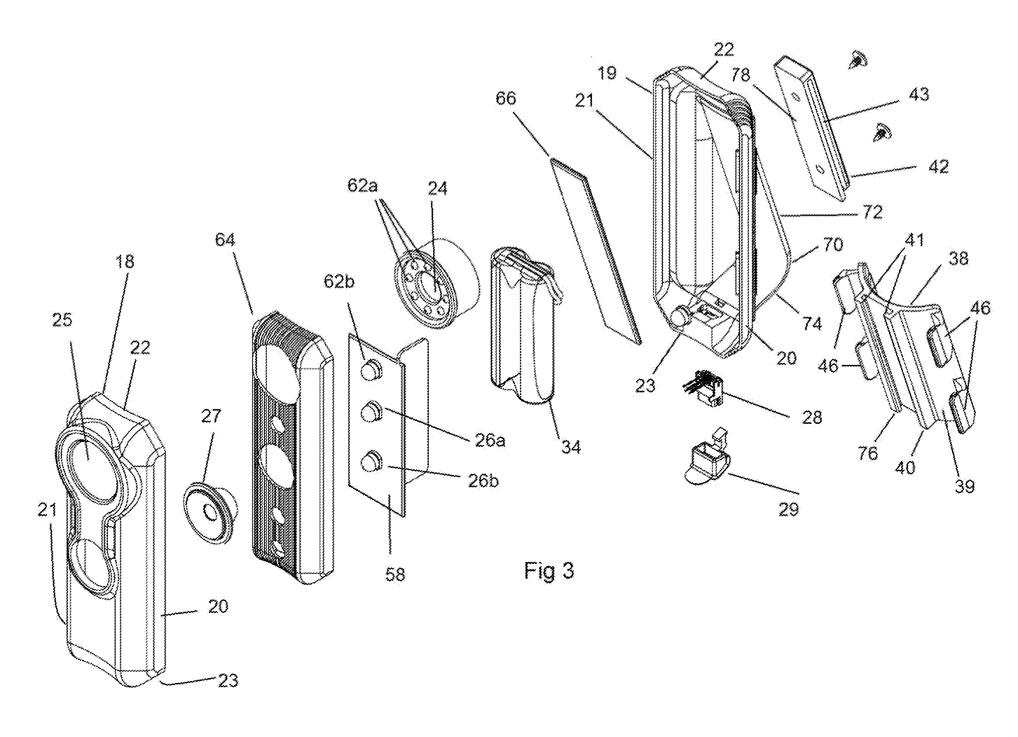

As can be seen in FIG. 3, the housing 12 comprises a first casing half 18 and, a second casing half 19. The first and second casing halves 18 and 19 are securable together to define a chamber within the housing 12. The first casing half 18 includes the first side surface 16 which is generally rectangular in shape. Opposed first and second side walls 20 and 21 extend generally transversely from opposed longitudinal sides of the first side surface 16 and opposed first and second end walls 22 and 23 extend generally transversely from opposed ends of the first side surface 16.

The second casing half 19 also includes first and second side walls 20 and 21 extending from opposed longitudinal sides of the second side surface 17 and opposed first and second end walls 22 and 23 extending from opposed ends of the second side surface 17.

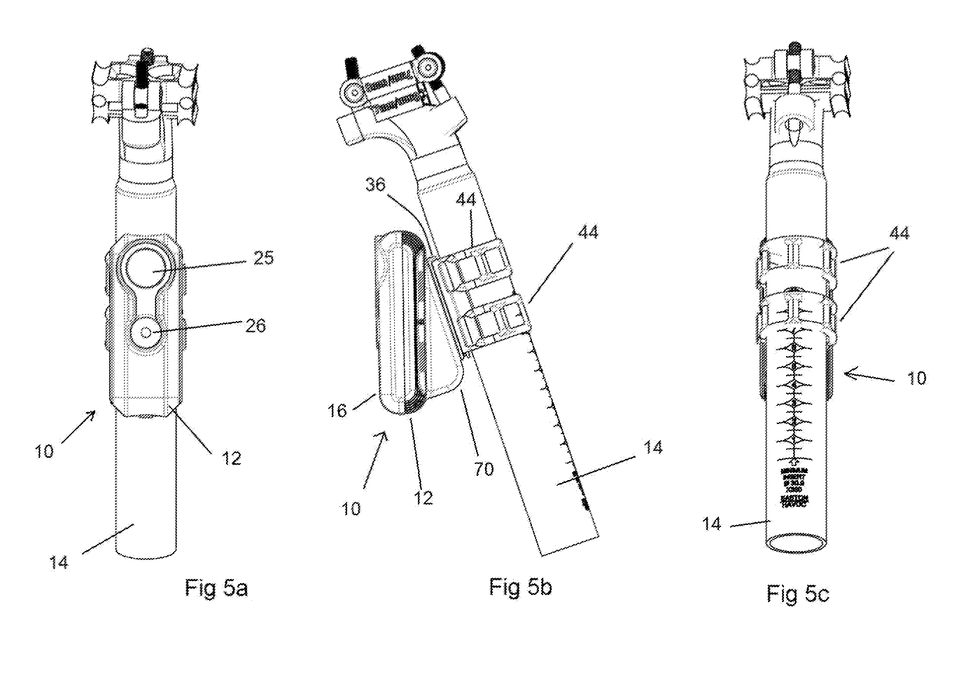

The second side surface 17 of the housing 12 includes a portion oriented at an angle to the first side surface 16 as can be seen in the Figures. The angle is such that when the housing 12 is secured to the seat post 14 with the portion of the second side surface 17 adjacent and parallel thereto, the first side surface 16 is generally vertical (as can be seen in FIG. 5b).

The second side surface 17 in the embodiment shown includes a projection 70 defining a first surface portion 72 and a second surface portion 74. The first surface portion 72 comprises a planar surface extending from adjacent the first end wall 22 to a location between the first and second end walls 22 and 23. The second surface portion 74 comprises a planar surface extending from the first surface portion 72 to adjacent the second end wall 23. The first and second surface portions 72 and 74 are angled relative to the first side surface 16 such that the projection 70 is generally a triangular prism in shape. The first surface portion 72 is oriented at an angle to the first side surface 16 of the housing 12 such that when the first surface portion 72 is located parallel and adjacent the seat post 14 the first side surface 16 is generally vertical. The first surface portion 72 is longer than the second surface portion 74 such that the intersection of the first and second surface portions 72 and 74 is closer to the second end wall 23 than the first end wall 22.

The housing 12 includes a camera 24 mounted therein. The camera 24 is mounted to extend through a clear window 25 provided in the first side surface 16 of the housing 12 such that when the housing 12 is secured to the seat post 14, the camera 24 points rearwardly of the bicycle 15. The housing 12 is provided also with a storage medium in connection with the camera 24. The storage medium is provided to store images recorded by the camera 24. The storage medium may be any suitable device, for example an SD or micro SD card. A camera circuit board 66 is also provided for the camera control circuitry. The storage medium may be removable from the housing 12 in order to connect with a suitable computer for retrieval of data.

The housing 12 is also provided with an associated audio input for recording audio along with the video. The audio is recorded to the storage medium.

The housing 12 is also provided with one or more tail lights 26. The tail lights 26 are mounted to illuminate outwardly of the first side surface 16 of the housing 12 such that the tail lights 26 point rearwardly of the bicycle 15 when the housing 12 is mounted to the seat post 14. The tail lights 26 thereby act as standard rear facing tail lights of the type usually used on bicycles. In the embodiment shown, there is provided a single strobe tail light 26a and a f further tail light 26b. The further tail lights 26b may be constantly illuminated or may flash in a pattern different to that of the strobe tail light 26a. The tail lights 26 are provided on a lighting circuit board 58 within the housing 12. The first casing half 18 is constructed of a transparent material such that the tail lights 26 illuminate rearwardly through the first casing half 18. The strobe light 26a may also be mounted through a reflector 27 to increase its effectiveness.

A battery pack 34 is provided within the housing 12 to power bath the camera 24 and the tail lights 26. The battery pack 34 preferably includes rechargeable batteries so that the bicycle camera 10 may be recharged between rides.

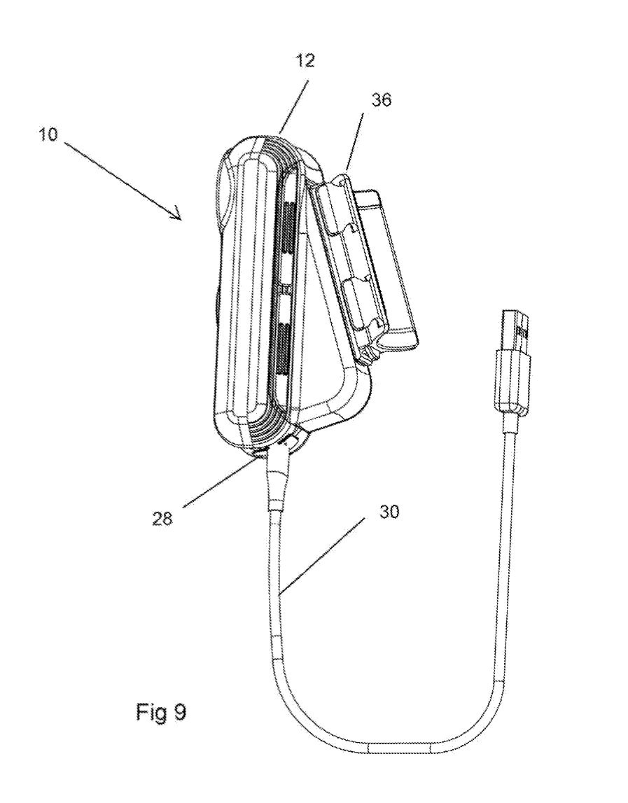

A cable connector′ 28 is also provided on the housing 12. The cable connector 28 is provided to connect to a suitable cable 30 (as shown in FIG. 9). The cable 30 provides connection for both power, to recharge the battery pack 34, and to retrieve stored image data from the storage medium. A waterproof cover 29 is preferably provided to seal across the cable connector 28 while riding to prevent water ingress.

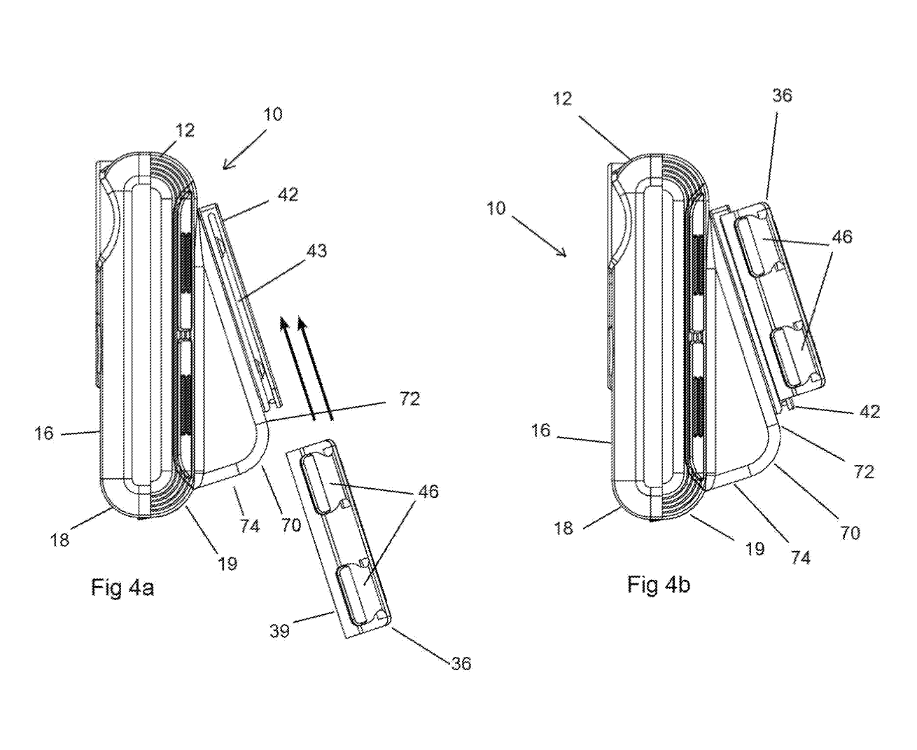

The housing 12 is provided with a mounting bracket 36 provided to secure the housing 12 to the seat post 14. The mounting bracket 36 comprises a member having convex first side surface 38 for engaging the circular surface of the seat post 14 and an opposed second side surface 39 having a first connector 76 thereon. The first connector 76 is provided to connect to a second connector 78 provided on the first surface portion 72 of the housing 12. The first connector 76 comprises a slot 40 extending longitudinally on the second side surface 39 of the mounting bracket 36. The second connector 78 comprises a rail 42 which is mounted to the second side surface 17 of the housing 12. The rail 42 includes grooves 43 along opposed longitudinal sides thereof and the slot 40 includes inwardly facing flanges 41 along opposed longitudinal sides. The mounting bracket 36 can therefore be attached to the housing 12 by sliding the rail 42 into the slot 40 such that the flanges 41 engage into the grooves 43, as shown in FIG. 4. The housing 12 may therefore be removed from the bicycle 15 as required.

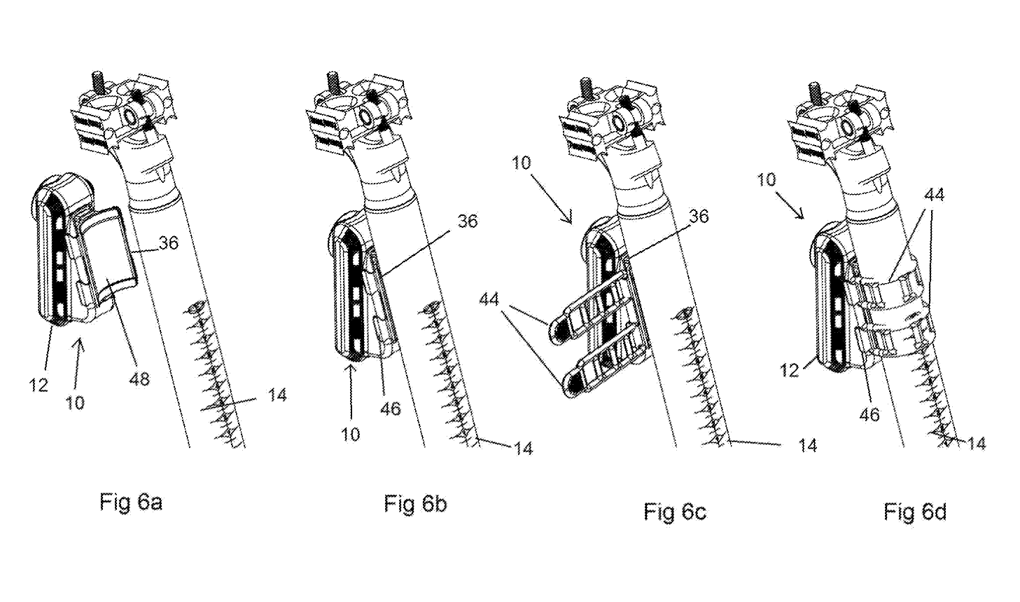

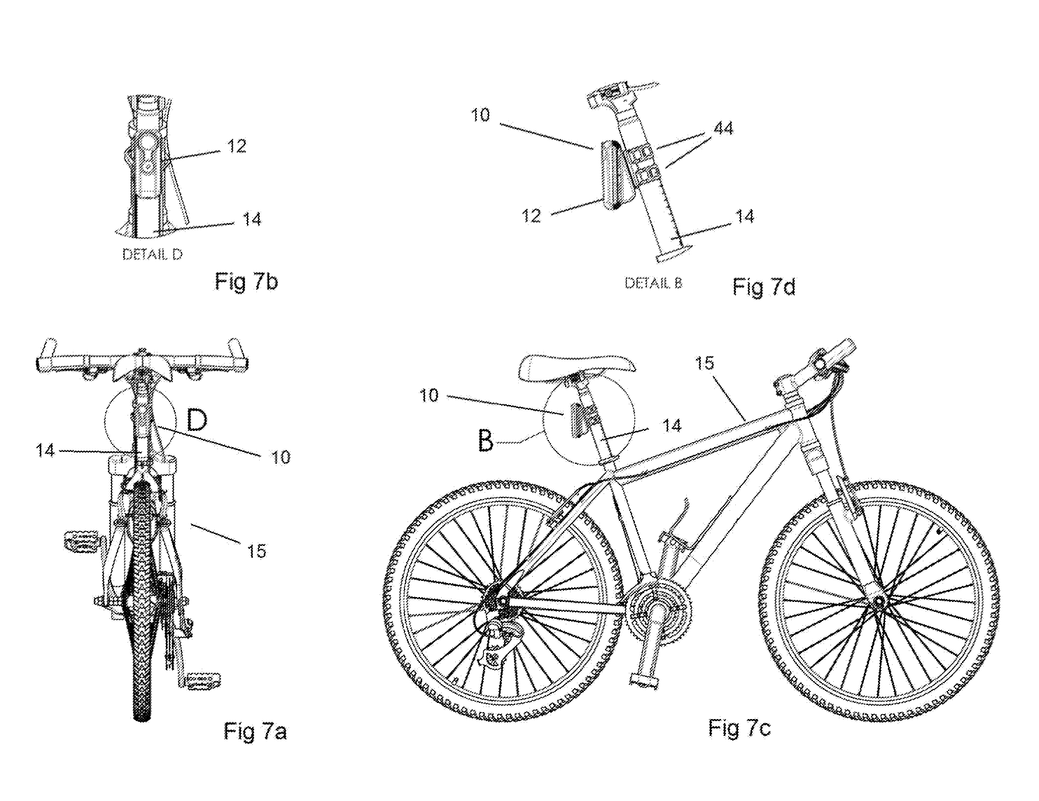

A plurality of straps 44 are provided for securing the mounting bracket 36 to the seat post 14. As can be seen in FIG. 6, the straps 44 include openings along the length thereof. The mounting bracket 36 is also provided with tabs 46 located on opposed edges thereof. The tabs 46 are provided to extend outwardly from the second side surface 39 of the mounting bracket 36 on opposed longitudinal edges thereof. An endmost opening is engaged over one of the tabs 46 and the strap 44 is then pulled around the seat post 14 to engage over a tab 46 on the opposite side. The straps 44 are formed of an elastic material such that the straps 44 can be stretched around the seat post 14 to engage the mounting bracket 36 firmly.

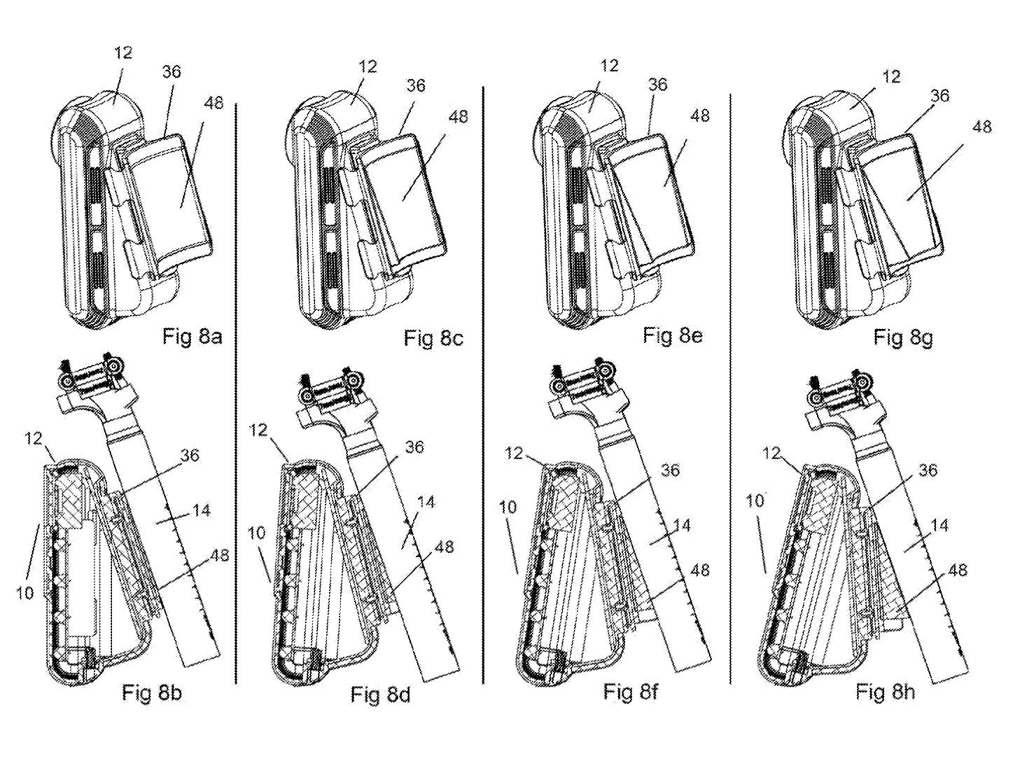

The mounting bracket 36 is provided with a resilient pad 48 to be placed on the first side surface 38 thereof. The pad 48 is also arcuate in shape to engage against the seat post 14. A plurality of pads 48 may be provided, each having a different taper from an upper end to a lower end. FIG. 8 shows four such pads 48, each having an increasing taper (that is, each having a thicker lower end). The most suitable pad 48 may therefore be selected for the angle of the seat post 14 in order to align the housing 12 vertically.

The housing 12 is also provided with one or more indicator lights 62. The indicator lights 62 are provided to give a visual indication when the camera 24 is recording. The indicator lights 62 are provided in a distinctive colour or colour combination, and/or with a distinctive flashing pattern. The distinctive pattern and/or colour is provided to give drivers of vehicles around the bicycle 15 a clear indication that the bicycle 15 includes a camera that is recording images and audio of events. In the embodiment shown, there is provided a first set of indicator lights 62a located around the camera 24. The first set of indicator lights 62a are provided in a ring around the camera 24 and may be set to sequentially flash in a circular pattern, a second indicator light 62b is provided on the lighting circuit board 58 and comprises a distinct colour (compared to the usual red or white lights used as tail lights on bicycles) and/or a further distinctive flashing sequence.

A reflector plate 64 is also provided between the lighting circuit board 58 and the first casing half 18. The reflector plate 64 includes holes for the lights 26 and 62 and the camera 24 and includes a reflective surface located adjacent an inner surface of the first casing half 18.

The bicycle camera 10 may also be provided with an angle sensor not shown) to detect if the angle of the housing 12 (and thereof of the bicycle 15) exceeds a predetermined angle. The angle sensor is in communication with the camera 24 such that the camera 24 may be stopped if the bicycle 15 is tilted beyond the predetermined angle for greater than a predetermined time. The angle sensor may comprise, for example, a mercury switch. In the case that a rider is knocked from the bicycle 15, the angle sensor will therefore stop the recording after a predetermined time. As the storage medium will have only a finite capacity and will be set to record in a loop, this will prevent data relating to the event being overwritten.

In use, the bicycle camera 10 can be secured to the seat post 14 of the bicycle 15. The bicycle camera 10 provides the required rear facing tail light 26 for the bicycle 15. It also provides a camera 24 which is securely mounted to the seat post 14 in a manner that reduces vibration and movement of the camera 24 such that a clear picture can be obtained from the camera 24 while the bicycle 15 is moving. The bicycle camera 10 also provides a clear visual indication to drivers that their actions are being recorded. This is expected to make drivers consider their actions around the bicycle 15. If any driver does act in an unsafe manner, audio and video of the incident may be downloaded from the storage medium to another device as evidence of the event.

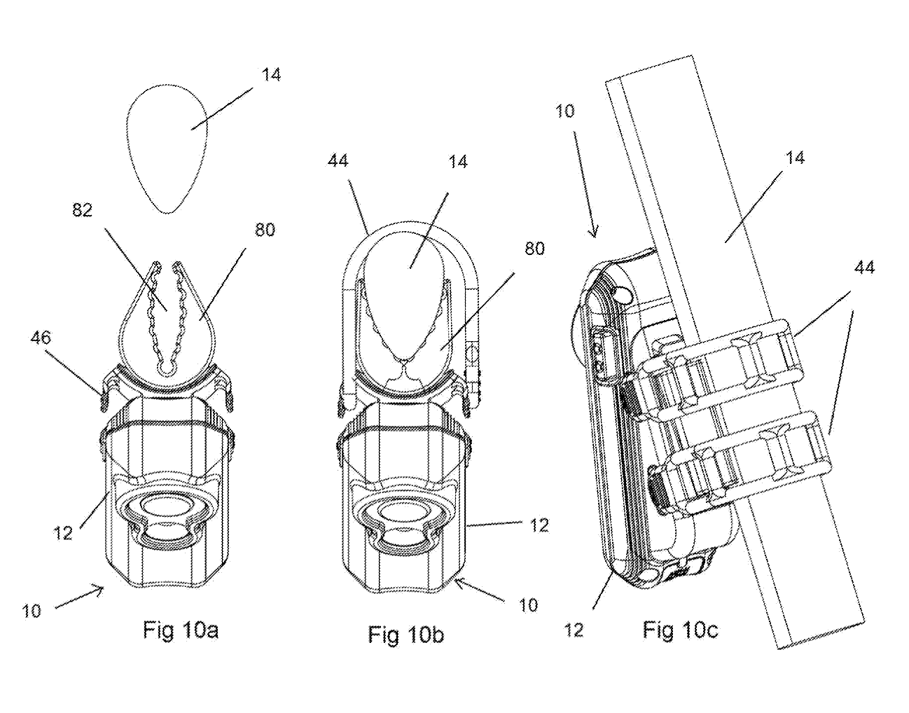

FIG. 10 shows an adaptor 80, that may be used in the cases where the rear side of the seat post 14 is a shape other than arcuate. In some bicycles, a tear drop shaped cross section may be used, such that the rear surface of the seat post 14 is of a more pointed shape. The adaptor 80 comprises a resilient tubular member having a slot 82 in a first side thereof. A second side of the adaptor 80 is arcuate such that the seat post 14 is received in the slot 82 and the arcuate second side engages against the arcuate first surface 38 of the mounting bracket 36.

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. A bicycle camera comprising:
a housing, mountable to a seat post of a bicycle;
a camera provided within the housing; and
a tail light provided within the housing;
wherein when the housing is secured to the seat post, the tail light provides illumination directed rearwardly of the bicycle and the camera is also directed rearwardly of the bicycle to capture images.

19. A bicycle camera in accordance with claim 18, wherein one or more indicator lights are provided in the housing such that the indicator lights illuminate when the camera is recording.

20. A bicycle camera in accordance with claim 19, wherein indicator lights are provided in a ring around the camera and flash sequentially in a circular pattern.

21. A bicycle camera in accordance with claim 20, wherein the housing includes a first side surface to be located remote from the seat post in use and a second side surface to be located adjacent the seat post, wherein the second side surface includes a portion oriented at an angle to the first side surface such that when the housing is secured to the seat post, the first side surface is generally vertical.

22. A bicycle camera in accordance with claim 21, wherein the second side surface includes a projection defining a first surface portion and a second surface portion, the first surface portion comprising a planar surface extending from adjacent the first end wall of the housing to a location between the first end wall and a second end wall of the housing and the second surface portion comprising a planar surface extending, from the first surface portion to adjacent the second end wall.

23. A bicycle camera in accordance with claim 22, wherein the first and second surface portions are angled relative to the first side surface such that the projection is generally a triangular prism in shape.

24. A bicycle camera in accordance with claim 23, wherein the first surface portion is longer than the second surface portion such that the intersection of the first and second surface portions is closer to the second end wall than the first end wall.

25. A bicycle camera in accordance with any one of claim 24, wherein the housing is provided with a mounting, bracket to secure the housing to the seat post, the mounting bracket comprising a member having convex first side surface for engaging the circular surface of the seat post and an opposed second side surface having a first connector thereon to engage with a second connector provided on the first surface portion of the housing.

26. A bicycle camera in accordance with claim 25, wherein the first connector comprises a slot extending longitudinally on the second side surface of the mounting bracket and the second connector comprises a rail which is mounted to the first surface portion of the housing, and wherein the rail includes grooves along opposed longitudinal sides thereof to receive inwardly facing flanges provided along opposed longitudinal sides of the slot.

27. A bicycle camera in accordance with claim 26, wherein the mounting bracket is provided with tabs extending outwardly from the second side surface thereof and a plurality of straps are provided, each including openings along the length thereof, such that an endmost opening in each strap may be engaged over one of the tabs and the strap then pulled around the seat post to engage over one of the tabs on the opposite side of the mounting bracket.

28. A bicycle camera in accordance with claim 27, wherein the straps are formed of an elastic material such that the straps can be stretched around the seat post to engage the mounting bracket firmly.

29. A bicycle camera in accordance with claim 28, wherein a resilient arcuate pad is provided to be placed on the first side surface of the mounting bracket.

30. A bicycle camera in accordance with claim 29, wherein the pad is tapered outwardly from an upper end to a lower end, wherein the taper is selected for the angle of the seat post in order to align the housing vertically.

31. A bicycle camera in accordance with claim 30, wherein a storage medium is to provided within the housing to store images captured by the camera.

32. A bicycle camera in accordance with claim 31, wherein a connector is provided on the housing for retrieval of data from the storage medium via a cable.

33. A bicycle camera in accordance with claim 32, wherein the housing comprises a first casing half and a second casing half, the first casing half being constructed of a transparent material and the tail lights and indicator lights being located to illuminate rearwardly through the first casing half.

34. A bicycle camera in accordance with claim 33, wherein an angle sensor is provided to detect if the angle of the bicycle exceeds a predetermined angle and to stop the camera recording after a predetermined time period.

35. A bicycle camera in accordance with claim 18, wherein the housing includes a first side surface to be located remote from the seat post in use and a second side surface to be located adjacent the seat post, wherein the second side surface includes a portion oriented at an angle to the first side surface such that when the housing is secured to the seat post, the first side surface is generally vertical.

36. A bicycle camera in accordance with claim 18, wherein the housing comprises a first casing half and a second casing half, the first casing half being constructed of a transparent material and the tail lights and indicator lights being located to illuminate rearwardly through the first casing half.

37. A bicycle camera in accordance with claim 18, wherein an angle sensor is provided to detect if the angle of the bicycle exceeds a predetermined angle and to stop the camera recording after a predetermined time period.
